(19) United States
(12) Patent Application Publication
(10) Pub. No.: US 2005/0217439 A1
(43) Pub. Date: Oct. 6, 2005

(54) Adjustable plier tool

(76) Inventor: Richard J. Macor, Hunterdon County, NJ (US)

Correspondence Address: Richard J. Macor;Proprietary Technologies, Inc., 26 Alpaugh Drive, Asbury, NJ, 08802-1213, US

(21) Appl. No.: 10/815,440

(22) Filed: Apr. 1, 2004

(51) Int. Cl. B25B 7/04

(52) U.S. Cl. 81/413

(57) ABSTRACT

The present invention involves an adjustable type plier tool comprising a first tool member pivotably attached to a second tool member. Each tool member has a handle portion, and a head portion comprising a jaw. The first tool member has a slot, and the second tool member has a pin attached thereto for interaction with the slot of the first tool member. The head portion of the first tool member has a distinct outer shape when the plier tool is viewed from a side view thereof. The distinct outer shape comprises a first section, a second section and a third section with the second section positioned between the first and third sections. The first section has a substantially convex curved outer shape, and the second section has a substantially concave curved outer shape, and, the third section has a substantially convex curved outer shape so as to provide the adjustable plier tool with excellent jaw engagement accessibility.

### REFERENCES TO RELATED APPLICATIONS

This application may relate to the following U.S. patents: U.S. Pat. Nos. D414,996; 6,484,610; and, 6,615,694, all of which have been granted to the inventor herein.

### FIELD OF THE INVENTION

The present invention relates to hand tools, particularly adjustable plier tools including tongue-and-groove type and slip-joint type varieties.

### BACKGROUND OF THE INVENTION

Hand operated plier tools have been around for many decades evolving slowly with very little change over many years. Prior art plier tools including tongue and groove type and slip joint type varieties are usually formed with two jaws, each having engaging work surfaces for pinching, gripping and/or controlling the rotation of a work piece. A typical prior art plier tool has a head and jaws formed with a configuration that often prohibits engagement with a work piece in confined work spaces or limit-access environments. Furthermore, the total length of a typical prior art plier tool often prohibits maneuverability and manipulation of the tool in confined work spaces and/or limited-access environments.

Accordingly, there is a need to improve upon the typical prior art plier tool and the deficiencies related to its jaw configuration and total length as described above.

### SUMMARY OF THE INVENTION

The present invention involves an adjustable type plier tool comprising a first tool member pivotably attached to a second tool member. Each tool member has a handle portion, and a head portion comprising a jaw. The first tool member has a slot, and the second tool member has a pin attached thereto for interaction with the slot of the first tool member. The head portion of the first tool member has a distinct outer shape when the plier tool is viewed from a side view thereof. The distinct outer shape comprises a first section, a second section and a third section with the second section positioned between the first and third sections. The first section has a substantially convex curved outer shape, and the second section has a substantially concave curved outer shape, and, the third section has a substantially convex curved outer shape so as to provide the adjustable plier tool with excellent jaw engagement accessibility.

Applicant recognizes the need for an improved adjustable type plier tool, and does accordingly consider the following objectives.

It is an important objective of the present invention described above, that it be structured having head and jaw members configured for optimal engagement to pinch, grip and/or control the rotation of a work piece in confined spaces or limited-access environments.

It is another important objective of the present invention described above, that it be structured having a shortened length (relative to the maximum spacing dimension between its jaws) to provide enhanced maneuverability and manipulation in confined work spaces and limited-access environments.

It is another important objective of the present invention described above, that it be structured for strength and durability.

It is another important objective of the present invention that it be structured so that a user may identify the benefits described above by the appearance of its unique “beak like” jaws and shortened length.

And, it is yet another important objective of the present invention described above, that it be cost efficient to manufacture, and commercially viable.

### BRIEF DESCRIPTION OF THE DRAWINGS

FIG. 1 shows left side view of a typical prior art, tongue groove type plier tool; and,

FIG. 2 shows a left side view of a prior art tool member, also shown in FIG. 1; and,

FIG. 3 shows a left side view of a present invention tool member, also shown in FIG. 4; and,

FIG. 4 shows a left side view of a present invention plier tool; and,

FIG. 5 shows a left side view of the head portion of another embodiment of the present invention.

### DETAILED DESCRIPTION OF THE DRAWINGS

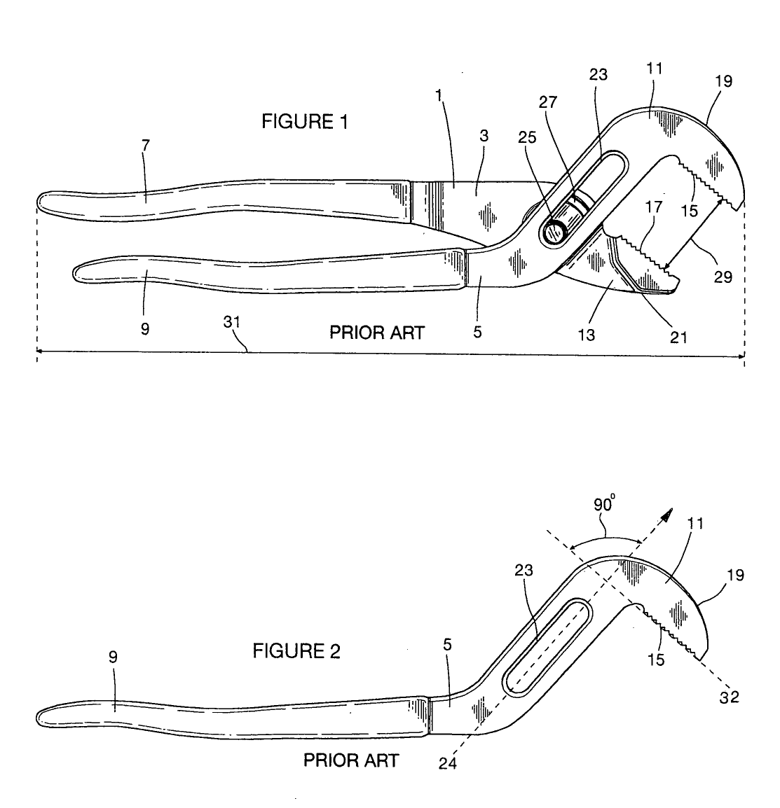

Referring now to the drawings which are for the purpose of illustrating preferred embodiments of the present invention and not for the purpose of limiting same, FIG. 1 shows left side view of a typical prior art, tongue groove type plier tool. Adjustable plier tool 1 comprises a first tool member 5 pivotably attached to a second tool member 3. Each tool member has a handle portion, and a head portion comprising a jaw. First tool member 5 has handle portion 9 and head portion 11 comprising jaw 15; and, second tool member 3 has handle portion 7 and head portion 13 comprising jaw 17. Second tool member 3 is formed having a pin 25 attached thereto for interaction with the slot 23 of first tool member 5. Plier tool 1 further has a tongue and groove means 27 incorporated therein to provide a plurality of spacing dimensions between jaws 15 and 17 of respective tool members 5 and 3. Some prior art, plier tools achieve the same plurality of spacing dimensions between the jaws without using a tongue and groove means, but only a pin and notched slot (not shown in this Figure.) In all embodiments of prior art plier tools known to applicant, the head portion 11 of first tool member 5 has a distinct outer shape 19, when plier tool 1 is viewed from a side view thereof as shown. A substantial portion of head 11 has a single, convex curved outer shape 19 as shown. This single, convex curved outer shape 19 is representative of virtually all adjustable type plier tools, and such a configuration prohibits plier tool 1 from achieving optimal engagement with a work piece in confined spaces and/or limited-access environments. Likewise, head portion 13 of second tool member 3 has a distinct outer shape 21, when plier tool 1 is viewed from a side view thereof as shown. A substantial portion of head 13 has a single, convex curved outer shape 21 as shown. This single, convex curved outer shape 21 is representative of virtually all adjustable type plier tools, and such a configuration further prohibits plier tool 1 from achieving optimal engagement with a work piece in confined spaces and/or limited-access environments.

In addition to the above, prior art plier tool 1 has a predetermined maximum spacing dimension 29 between jaws 15 and 17 as shown, and, a predetermined total length 31 as shown. Prior art, plier tool 1 which is representative of most prior art, adjustable type plier tools has a total length equal to about 6.5 times the maximum spacing dimension between the jaws. Such a prior art configuration further prohibits maneuverability and manipulation in confined work spaces and/or limited-access environments. Therefore, a typical prior art plier tool has at least one head comprising a jaw formed having a configuration that prohibits the plier tool from achieving optimal engagement with a work piece in confined work spaces and/or limit-access environments. Furthermore, the total length of a typical prior art plier tool (relative to the maximum spacing dimension between its jaws) often prohibits optimal maneuverability and manipulation of the tool in confined work spaces and/or limited-access environments.

FIG. 2 shows a left side view of a prior art tool member, also shown in FIG. 1. Tool member 5 has a handle portion 9, and a head portion 11 comprising a jaw 15 as shown. Tool member 5 is formed having a slot 23 extending in a predetermined direction 24. Jaw 15 has engaging work surfaces creating an imaginary line 32 which is substantially perpendicular to the predetermined direction 24 of the extending slot 23. A substantial portion of head 11 has a single, convex curved outer shape 19 as shown. This single, convex curved outer shape 19 is representative of most, if not all adjustable type plier tools, and such a configuration prohibits the plier tool from achieving optimal engagement with a work piece in confined spaces and/or limited-access environments.

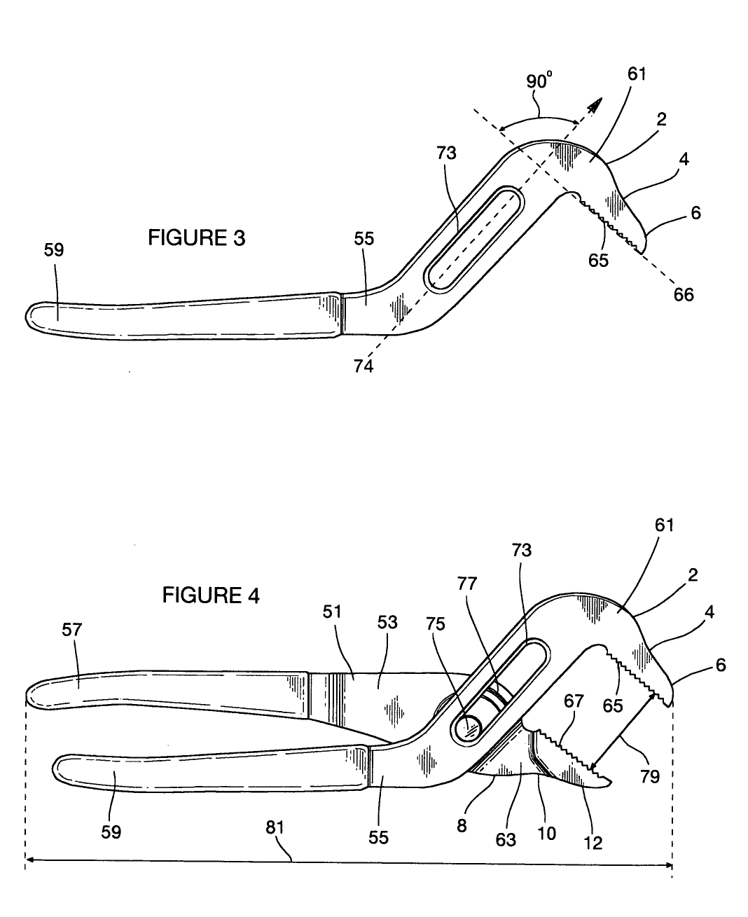

FIG. 3 shows a left side view of a present invention tool member, also shown in FIG. 4. Tool member 55 has a handle portion 59, and a head portion 61 comprising a jaw 65 as shown. Tool member 55 is formed having a slot 73 extending in a predetermined direction 74. Jaw 65 has engaging work surfaces creating an imaginary line 66 which is substantially perpendicular to the predetermined direction 74 of extending slot 73. Preferred embodiments of the present invention plier tool may have such a configuration; however, it is possible for the engaging work surfaces to create an imaginary line that is not perpendicular to the predetermined direction of the extending slot 73. Head portion 61 of tool member 55 has a distinct outer shape when viewed from a side view thereof as shown. The unique and distinct shape of head 61 which comprises jaw 65, includes a first section 2 which has a substantially convex curved outer shape as shown, and a second section 4 which has a substantially concave curved outer shape as shown, and, a third section 6 which has a substantially convex curved outer shape as shown. The second section is positioned between the first and third sections as shown. Head and jaw sections 2, 4 and 6 combine to form a distinct head and jaw configuration intended for optimal engagement with a work piece in confined spaces and/or limited-access environments.

FIG. 4 shows a left side view of a present invention, adjustable plier tool 51 comprising a first tool member 55 (also shown in FIG. 3) pivotably attached to a second tool member 53. Each tool member has a handle portion, and a head portion comprising a jaw. First tool member 55 has handle portion 59 and head portion 61 comprising jaw 65; and, second tool member 53 has handle portion 57 and head portion 63 comprising jaw 67. The first tool member is formed with a slot 73, and the second tool member 53 is formed having a pin 75 attached thereto for interaction with the slot 73 of first tool member 55. Plier tool 51 further has a tongue and groove means 77 incorporated therein to provide a plurality of spacing dimensions between jaws 65 and 67 of respective tool members 55 and 53. The tongue and groove adjustable type means is well known in the industry and understood by those skilled in the art. It is possible that the adjustable means may only include a pin and a notched slot without a tongue and groove configuration. This type of adjustable means is also well known in the industry and understood by those skilled in the art. Preferred embodiments of the present invention could include either of these known adjustable means to provide a plurality of spacing dimensions between jaws 65 and 67 of respective tool members 55 and 53.

In all embodiments of the present invention, the head portion 61 of first tool member 55 has a distinct outer shape when plier tool 51 is viewed from a side view thereof as shown. The unique and distinct shape of head 61 which comprises jaw 65, includes a first section 2 which has a substantially convex curved outer shape as shown, and a second section 4 which has a substantially concave curved outer shape as shown, and, a third section 6 which has a substantially convex curved outer shape as shown. The second section is positioned between the first and third sections as shown. Head and jaw sections 2, 4 and 6 combine to form a distinct head and jaw configuration intended for optimal engagement with a work piece in confined spaces or limited-access environments. In the most preferred embodiments of the present invention, the head portion 63 of second tool member 53 will likewise, also have a distinct outer shape when plier tool 51 is viewed from a side view thereof as shown. The unique and distinct shape of head 63 which comprises jaw 67, includes a first section 8 which has a substantially convex curved outer shape as shown, and a second section 10 which has a substantially concave curved outer shape as shown, and, a third section 12 which has a substantially convex curved outer shape as shown. The second section is positioned between the first and third sections as shown. Jaw sections 8, 10 and 12 combine to form a distinct head and jaw configuration intended for optimal engagement with a work piece in confined spaces or limited-access environments.

In some preferred embodiments of the present invention, plier tool 51 will have a predetermined maximum spacing dimension 79 between the jaws as shown, and, the same plier tool will also have a predetermined total length 81 as shown. In preferred embodiments of the present invention, the total length of the plier tool will be generally equal to or greater than five times the predetermined maximum spacing dimension between the jaws, and, generally equal to or less than six times the predetermined maximum spacing dimension between the jaws. For example, the plier tool may have a maximum spacing dimension of 1.5 inches between the jaws, and a predetermined total length of 7.5 inches. In such a configuration, the total length of 7.5 inches would be about 5 times the maximum spacing dimension of 1.5 inches between the jaws. Such a configuration further provides prior tool 51 with enhanced maneuverability and manipulation in confined work spaces and limited-access environments.

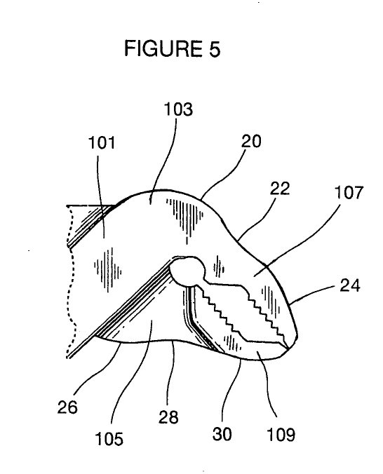

FIG. 5 shows a left side view of the head portion of another embodiment of the present invention. Shown is plier tool 101 having a first head portion 103, and a second head portion 105. Head portion 103 has a distinct outer shape when plier tool 101 is viewed from a side view thereof as shown. The unique and distinct shape of head 103 which comprises jaw 107, includes a first section 20 which has a substantially convex curved outer shape as shown, and a second section 22 which has a substantially concave curved outer shape as shown, and, a third section 24 which has a substantially convex curved outer shape as shown. The concave curved outer shape 22 is positioned between the convex curved outer shapes 20 and 24 of the first and third sections respectively as shown. Jaw sections 20, 22 and 24 combine to form a distinct head and jaw configuration intended for optimal engagement with a work piece in confined spaces or limited-access environments. Likewise, head portion 105 has a distinct outer shape when plier tool 101 is viewed from a side view thereof as shown. The unique and distinct shape of head 105 which comprises jaw 109, includes a first section 26 which has a substantially convex curved outer shape as shown, and a second section 28 which has a substantially concave curved outer shape as shown, and, a third section 30 which has a substantially convex curved outer shape as shown. The concave curved outer shape 28 is positioned between the convex curved outer shapes 26 and 30 of the first and third sections respectively as shown. Jaw sections 26, 28 and 30 combine to form a distinct head and jaw configuration intended for optimal engagement with a work piece in confined spaces or limited-access environments.

When considering the present invention, simplicity and obviousness should not be confused or considered the same. Accordingly, the novelty and complexity of the present invention must be measured by the many interrelated objectives set forth herein.

Upon reading and understanding the specification of the present invention described above, modifications and alterations will become apparent to those skilled in the art. It is intended that all such modifications and alterations be included insofar as they come within the scope of the patent as claimed or the equivalence thereof.

1. An adjustable type plier tool comprising a first tool member pivotably attached to a second tool member, each said tool member having a handle portion, and a head portion comprising a jaw; said first tool member being formed having a slot, said second tool member being formed having pin attached thereto for interaction with the slot of said first tool member, the head portion of said first tool member having a distinct outer shape when said plier tool is viewed from a side view thereof, the distinct outer shape comprising a first section, a second section and a third section with the second section positioned between said first and third sections, and, the first section having a substantially convex curved outer shape, the second section having a substantially concave curved outer shape, and, the third section having a substantially convex curved outer shape so as to provide said adjustable plier tool with excellent jaw engagement accessibility.

2. A plier tool of claim 1, wherein the head portion of said second tool member has a distinct outer shape when said plier tool is viewed from a side view thereof, the distinct outer shape comprising a first section, a second section and a third section with the second section positioned between said first and third sections, and, the first section having a substantially convex curved outer shape, the second section having a substantially concave curved outer shape, and, the third section having a substantially convex curved outer shape so as to provide said adjustable plier tool with excellent jaw engagement accessibility.

3. A plier tool of claim 1, wherein said plier tool has a predetermined maximum spacing dimension between said jaws, and said plier tool has a predetermined total length, and, the total length of said plier tool is generally equal to or less than six times the predetermined maximum spacing dimension between said jaws.

4. A plier tool of claim 1, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.

5. A plier tool of claim 1, wherein said plier tool further comprises a tongue and groove means incorporated therein to provide a plurality of spacing dimensions between the jaws of said tool members.

6. A plier tool of claim 5, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.

7. A plier tool of claim 2, wherein said plier tool has a predetermined maximum spacing dimension between said jaws, and said plier tool has a predetermined total length, and, the total length of said plier tool is generally equal to or less than six times the predetermined maximum spacing dimension between said jaws.

8. A plier tool of claim 2, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.

9. An adjustable type plier tool comprising a first tool member pivotably attached to a second tool member, each said tool member having a handle portion, and a head portion comprising a jaw; said first tool member being formed having a slot extending in a predetermined direction, the jaw of said first tool member having engaging work surfaces creating an imaginary line substantially perpendicular to the predetermined direction of said extending slot, said second tool member being formed having pin attached thereto for interaction with the slot of said first tool member, the head portion of said first tool member further having a distinct outer shape when said plier tool is viewed from a side view thereof, the distinct outer shape comprising a first section, a second section and a third section with the second section positioned between said first and third sections, and, the first section having a substantially convex curved outer shape, the second section having a substantially concave curved outer shape, and, the third section having a substantially convex curved outer shape so as to provide said adjustable plier tool with excellent jaw engagement accessibility.

10. A plier tool of claim 9, wherein the head portion of said second tool member has a distinct outer shape when said plier tool is viewed from a side view thereof, the distinct outer shape comprising a first section, a second section and a third section with the second section positioned between said first and third sections, and, the first section having a substantially convex curved outer shape, the second section having a substantially concave curved outer shape, and, the third section having a substantially convex curved outer shape so as to provide said adjustable plier tool with excellent jaw engagement accessibility.

11. A plier tool of claim 9, wherein said plier tool has a predetermined maximum spacing dimension between said jaws, and said plier tool has a predetermined total length, and, the total length of said plier tool is generally equal to or less than six times the predetermined maximum spacing dimension between said jaws.

12. A plier tool of claim 9, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.

13. A plier tool of claim 10, wherein said plier tool has a predetermined maximum spacing dimension between said jaws, and said plier tool has a predetermined total length, and, the total length of said plier tool is generally equal to or less than six times the predetermined maximum spacing dimension between said jaws.

14. A plier tool of claim 10, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.

15. An adjustable type plier tool comprising a first tool member pivotably attached to a second tool member, each said tool member having a handle portion, and a head portion comprising a jaw; said first tool member being formed having a slot extending in a predetermined direction, the jaw of said first tool member having engaging work surfaces creating an imaginary line substantially perpendicular to the predetermined direction of said extending slot, said second tool member being formed having a pin attached thereto for interaction with the slot of said first tool member, said plier tool further having a tongue and groove means incorporated therein to provide a plurality of spacing dimensions between the jaws of said tool members, the head portion of said first tool member further having a distinct outer shape when said plier tool is viewed from a side view thereof, the distinct outer shape comprising a first section, a second section and a third section with the second section positioned between said first and third sections, and, the first section having a substantially convex curved outer shape, the second section having a substantially concave curved outer shape, and, the third section having a substantially convex curved outer shape so as to provide said adjustable plier tool with excellent jaw engagement accessibility.

16. A plier tool of claim 15, wherein the head portion of said second tool member has a distinct outer shape when said plier tool is viewed from a side view thereof, the distinct outer shape comprising a first section, a second section and a third section with the second section positioned between said first and third sections, and, the first section having a substantially convex curved outer shape, the second section having a substantially concave curved outer shape, and, the third section having a substantially convex curved outer shape so as to provide said adjustable plier tool with excellent jaw engagement accessibility.

17. A plier tool of claim 15, wherein said plier tool has a predetermined maximum spacing dimension between said jaws, and said plier tool has a predetermined total length, and, the total length of said plier tool is generally equal to or less than six times the predetermined maximum spacing dimension between said jaws.

18. A plier tool of claim 15, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.

19. A plier tool of claim 16, wherein said plier tool has a predetermined maximum spacing dimension between said jaws, and said plier tool has a predetermined total length, and, the total length of said plier tool is generally equal to or less than six times the predetermined maximum spacing dimension between said jaws.

20. A plier tool of claim 16, wherein said plier tool has a predetermined maximum spacing dimension between said jaws, and said plier tool has a predetermined total length, and, the total length of said plier tool is generally equal to or greater than five times the predetermined maximum spacing dimension between said jaws and generally equal to or less than six times the predetermined maximum spacing dimension between said jaws.
